(19) United States
(12) Patent Application Publication
(10) Pub. No.: US 2008/0077556 A1
(43) Pub. Date: Mar. 27, 2008

(54) System and method for applying real-time optimization of internet websites for improved search engine positioning

(76) Inventor: Juan Carlos Muriente, Cabo Rojo, PR (US)

Correspondence Address: EUGENIO J. TORRES, 221 PLAZA BUILDING, PONCE DE LEON, SUITE 403, SAN JUAN, PR, 00917, US

(21) Appl. No.: 11/904,002

(22) Filed: Sep. 24, 2007

Related U.S. Application Data
(60) Provisional application No. 60/846,430, filed on Sep. 23, 2006.

(51) Int. Cl. G06F 17/30

(52) U.S. Cl. 707/2; 707/E17.014

(57) ABSTRACT

A system and method providing real-time search engine optimization comprising creating a static URL addressing and hierarchical structure, analysis to determine an optimized search engine configuration for each Web page or document, and dynamic processing for each Web page requested by an end user or search engine crawler.

### RELATED APPLICATIONS

This application in base on and claim the benefit of the filing date of provisional application Ser. No. 60/846,430 filed on Sep. 23, 2007.

### BACKGROUND OF THE INVENTION

1. Field of the Invention

The present invention relates generally to Internet search engines. More specifically, this invention relates to a system for optimizing a document or collection of documents hosted on an Internet Web server (referred to as “Web pages” and “Web sites”, respectively) to achieve improved search engine positioning, applied dynamically in real-time.

2. Discussion of the Invention

A search engine is a software program hosted on Internet Web servers that indexes Web sites and Web pages on the World Wide Web, and allows end users to search the index for sites and/or pages that match their search query, i.e. a keyword or keyword phrase that may include Boolean logic (and, or, not, etc) or search engine specific operators. While Web pages are typically authored using various document type definitions, such as HTML, intended specifically for use on the World Wide Web, search engines may also include in their search index, other document formats including, but not limited to, word processor documents (e.g. MS Word) or Adobe PDF.

When a particular query is submitted to the search engine several results are provided to the user wherein each result has a search engine position. The search engine positioning is defined as the numeric position in which a Web page (or document having another format) is included within a list of Search Engine Results Pages (“SERPs”) as a response to a user-generated query for a particular text keyword or keyword phrase. Based on its own proprietary evaluation criteria, each search engine determines the positioning for all Web pages and documents contained within its index for each text keyword or keyword phrase in the SERPs. In order for a Web page or document to be eligible to be included and positioned within the SERPs for a particular user query, the Web page (or its parent Web site) must be subjected to the search engine's algorithms for crawling, indexing, and ranking. In the art the term Crawling is used for the process which a search engine discovers a Web page or document on the Internet and stores its address and/or retrieves its content, indexing is the process by which a search engine analyzes a crawled Web page or document, applies its data using proprietary techniques, and stores the data it in its index and ranking is the process which a search engine determines which of the Web pages and/or documents contained in its index will be returned in response to a specific keyword or keyword phrase included in a user-generated query, and in what numeric position.

In order to improve the position of a Web page or Web-site at a Search engine the Web page or Web-site has to be optimized. The search engine optimization (“SEO”) refers generically to any technique applied to a Web page (or other document formats), Web site, or Web site sub-section in order to facilitates and improves the process of having a search engine crawl Web pages or documents located on a Web site faster, more often, more efficiently, and more completely (i.e. higher percentage of the total Web page or document collection crawled), and improving the likelihood of having a search engine include Web pages or documents in its search index, so that it is eligible to be returned within the SERPs for various user generated search queries. Also in order to improve the likelihood of having a Web page or document included (or ranked) for a particular keyword or keyword phrase query, and ranking in a better position (i.e. lower numeric occurrence) within the SERPs for each of the user-generated queries.

Having more Web pages and documents included in the various search engine indices (e.g. Google, Yahoo!, MSN Search), and ranking at higher positions generates more visitors from the search engine to the Web sites where they are published. Having higher levels of traffic or visitors to a Web site is an important factor for success, just as viewers or readers are important to traditional media including print, television, and radio. In fact, an entire industry has emerged for this purpose, referred to as SEM or Search Engine Marketing. Search Engine Marketing includes various methods of generating traffic to Web sites including advertising such as Pay-Per-Click advertising (e.g. Google AdWords). SEO is one of the more prominent traffic generating segments of the SEM industry.

Generally, the exact details of search engine crawling, ranking, and indexing algorithms represent proprietary information that is generally not disclosed by the various search engines. Further, these algorithms are modified and upgraded periodically with the primary goals of improving the quality of the search engine results provided to users in response to their submitted search queries; and preventing those skilled in search engine optimization from unfairly manipulating the search engine results. Therefore generally accepted search engine optimization strategies are developed from and based on general information provided from search engines on how their algorithms work; general information provided by those who have tested search engine optimization strategies and achieved positive or negative results; untested theories provided by those with knowledge of search engine optimization; interpretation of patent filings assigned to search engine companies; best practices commonly discussed and supported within search engine optimization or webmaster communities on the Internet; and using supported search engine related components included in language specifications, such as HTML meta tags, or the robots.txt protocol (especially those that have an official standards body or RFC).

For this reason, the present invention is not tethered to specific search engine optimization techniques, in its general embodiment. The various search engine optimization techniques (both current and future) must be adaptable, configurable, and subject to deprecation at such time as they no longer provide SEO advantages or are associated with negative SEO effects.

There are several existing types of search engine optimization software and Web based services available; however, they take a differing approach that does not provide the flexibility or quality of results provided by the present invention. The categories of existing search engine optimization include:
Manual pre-publication search engine optimization;
Search engine optimization features embedded natively in publishing platforms; and
Search engine analysis software.

### Manual Pre-Publication SEO

Many Web sites are published using desktop publishing software, and are then transferred to a Web server where they become available as a Web page on the World Wide Web. These documents, typically in HTML format, are static in nature and not intended to be changed very often (referred to as static). When the content of the document requires revision, the document is again modified offline within the desktop publishing software and then re-uploaded to the Web server.

It is at this stage that various search engine optimizations can be manually applied prior to upload (i.e. pre-publication). Various desktops publishing software (or Web editors) contained special features to automate the application of some SEO features such as the automatic inclusion of optimized META tags within the Web page.

SEO features included in desktop publishing software or Web editors are generally very limited. Once the Web pages or documents (created with the desktop publishing software) are published to the Web site, their SEO characteristics are static and do not change. This inflexibility ensures that as search engine algorithms and generally accepted search engine optimization strategies change, the Web pages will become less and less optimized for search engine positioning.

Static Web pages or documents do have an advantage for search engine crawling and indexing since many search engine crawlers have difficulty fully crawling and indexing the structure of a dynamic site due to the changing address structure and URLs (uniform resource locators), that pass data using query strings.

### SEO Features Embedded Natively in Publishing Platforms

Internet publishing platforms are typically software applications hosted on an Internet Web server that are designed to enable the publication of Web documents and provide them to end users who request them on the World Wide Web.

A publishing platform, in the most general form, would be considered the Web server software itself that is responsible for receiving incoming requests for Web pages, processing the request, and returning the content to the end user via an Internet network connection. Some of the other major categories of publishing platforms include:

content management systems (CMS)

eCommerce systems

news systems

forums (also referred to as electronic bulletin board systems)

blogs

photo galleries

support ticketing systems

There are also many custom-programmed systems developed using Web development languages including PHP, ASP, Java, Perl, etc. in combination with a backend database system such as MySQL.

Each publishing platform category is designed to publish a specific type of content. Additionally, each system may be designed to include some SEO related features embedded within the logic. For example, a CMS designed to publish articles might automatically generate optimized META tags at the time the article is published using the system. However, SEO related features are generally limited or not provided.

There is a fundamental issue involved with embedding SEO features within any type of publishing platform. As stated previously, search engine algorithms are proprietary information not generally released by the various search engine companies, and are constantly changing in order to boost the quality of search engine results for end users and to prevent SEO experts from unfairly influencing the results. Therefore, embedding SEO features within a publishing platform will add an extra level of complexity to the development life cycle. In addition, the software will require constant updates to adjust for changes in the search engine algorithms and generally accepted search engine optimization strategies.

A large part of the task of search engine optimizing a Web site involves monitoring and analyzing search engine positioning to determine if the results are positive, negative, or neutral and then adjusting SEO strategies and techniques to try to improve. This process requires a level of flexibility that is impractical and has not yet been achieved in any Web publishing platform.

Software architects generally design and develop software using a 3-layer architecture:
User Interface—Layer controlling display in which an end user receives and/or transmits information back to the publishing platform.
Business Logic—Layer at which data is retrieved from the end user and/or data layer, processed and used to render the user interface.
Data—Layer that contains all data required for short-term or long-term storage of information to be processed in the business logic layer.

Once a Web page is rendered and provided to an end user or search engine crawler, it would be considered to be at the user interface layer. However, SEO should not be considered to be integrated only at the user interface level. Since search engines rank Web pages or documents based on their contents, SEO must also be considered at the business logic and data layers as well. However, integrating SEO at each layer for a publishing platform is impractical.

Web publishing platforms with embedded SEO features do have an advantage since they allow for some of the SEO to occur in real-time when a dynamic addressing structure is used. However, as discussed in the “Manual Pre-Publication SEO” section, static addressing structures have an advantage over dynamic because of search engines known limitations in crawling and indexing URLs that change and pass data using query strings.

### Search Engine Analysis Software

Search engine software or Web services are designed to evaluate an existing Web site for search engine optimization and provide information on what steps should be taken in order to improve the search engine positioning.

However, the improvements are not automatically applied. Therefore, it is required that the Web site be updated via the desktop publishing software or publishing platform used to create and publish it to the World Wide Web.

While SEO analysis software may be up to date with current generally accepted search engine optimization strategies, it is limited in that it primarily generates reports on steps that have to be completed in another system in order to optimize the Web site being analyzed.

### Specific Types of Search Engine Optimization Software

There are various types of existing search engine optimization software including:

| | |
|---|---|
| Browser Toolbars/Plugins | Competitor Analysis |
| Automated Link Submitters/ | Keyword Density Analyzers |
| Link Exchange Managers | Keyword Suggestion Tools |
| Link Analyzers/Link | Code Validators |
| Validators/Reciprocal Link | Sitemap Generators |
| Checkers | Web Traffic Statistic |
| PageRank Analyzers | Packages/Log Analyzers |
| Meta Tag Generators/ | |
| Optimizers | |
| Position Trackers/Rank | |
| Checkers | |

In addition to the foregoing, several methods or systems in the prior art disclose other systems and methods designed to improve Internet searching. For instance, U.S. Pat. No. 6,754,873 to Law et al. discloses various techniques for finding related hyperlinked documents using link-based analysis. In this invention, backlink and forwardlink sets are utilized to find web pages that are related to a selected web page. The scores for links from web pages that are from the same host and links from web pages with numerous links can be reduced to achieve a better list of related web pages. The list of related web pages can be utilized as a feature to a word-based search engine or an addition to a web browser.

U.S. Pat. No. 6,725,259 to Bharat discloses a method of ranking search results by reranking the results based on local inter-connectivity. A search engine for searching a corpus improves the relevancy of the results by refining a standard relevancy score based on the interconnectivity of the initially returned set of documents. The search engine obtains an initial set of relevant documents by matching a user's search terms to an index of a corpus. A re-ranking component in the search engine then refines the initially returned document rankings so that documents that are frequently cited in the initial set of relevant documents are preferred over documents that are less frequently cited within the initial set.

U.S. Pat. No. 6,718,324 to Edlund et al. discloses a Metadata search results ranking system which utilizes a combination of popularity and/or relevancy to determine a search ranking for a given search result association. This invention provides a method by which searches of this vast distributed database can produce useful results ranked and sorted by usefulness to the searching web surfer.

U.S. Pat. No. 6,714,929 to Micaelian et al. discloses a weighted preference data search system and method comprising a search engine for databases, data streams, and other data sources that allows user preferences as to the relative importance of search criteria to be used to rank the output of the search engine. A weighted preference generator generates weighted preference information including at least a plurality of weights corresponding to a plurality of search criteria. A weighted preference data search engines uses the weighted preference information to search a data source and to provide an ordered result list based upon the weighted preference information. A method for weighted preference data searching includes determining weighted preference information including a plurality of search criteria and a corresponding plurality of weights signifying the relative importance of the search criteria, and querying a data source and ranking the results based upon the weighted preference information. In addition to allowing client input of the relative importance of various search criteria, the system and method also preferably include the ability to provide a subjective ordering for at least some of the search criteria.

U.S. Pat. No. 5,864,863 to Burrows discloses a method for parsing, indexing, and searching world-wide-web pages. A system indexes Web pages of the Internet. The pages are stored in computers distributively connected to each other by a communications network. Each page has a unique URL (universal record locator). Some of the pages can include URL links to other pages. A communication interface connected to the Internet is used for fetching a batch of Web pages from the computers in accordance with the URLs and URL links. The URLs are determined by an automated Web browser connected to the communications interface. A parser sequentially partitions the batch of specified pages into indexable words where each word represents an indexable portion of information of a specific page, or the word represents an attribute of one or more portions of the specific page. The parser sequentially assigns locations to the words as they are parsed. The locations indicate the unique occurrences of the word in the Web. The output of the parser is stored in a memory as an index. The index includes one index entry for each unique word. Each index entry also includes one or more location entries indicating where the unique word occurs in the Web. A query module parses a query into terms and operators. The operators relate the terms. A search engine uses object-oriented stream readers to sequentially read location of specified index entries, the specified index entries correspond to the terms of a query. A display module presents qualified pages located by the search engine to users of the Web.

Therefore, it can be appreciated that there exists a prevalent necessity for new and improved Optimization of Websites for Improved Search Engine Positioning. In this regard, the present invention substantially fulfills this need. The present invention overcomes the inability of the prior art to foresee the need to optimize the structure, code, and content of a Web Page for improved crawling, indexing and ranking.

None of the prior art considered above, taken either simply or in combination teaches the use optimization techniques to optimize a Web Site for improved crawling, indexing and ranking. In light of the foregoing, it will be appreciated that what is needed in the art is a system and method that combines the search engine optimization software, without the restrictive limitations, inflexibility, and disadvantages.

### SUMMARY OF THE INVENTION

The invention optimizes Web sites or web pages improving crawling, indexing and ranking. The general embodiment of the invention allows for real-time SEO optimization including creating a static URL addressing and hierarchical structure, analysis to determine an optimized search engine configuration for each Web page or document, and dynamic processing for each Web page requested by an end user or search engine crawler. It is also able to deliver generally accepted SEO strategies at all levels (user interface, business logic and data) with minimal integration with the publishing platform. This allows the system to operate concurrently with the publishing system, providing all SEO advantages, regardless of the publishing platform used.

Another object of the present invention is to provide search engine optimization software, without the restrictive limitations, inflexibility, and disadvantages thereof.

It is a further object of the present invention to provide a method that allows for real-time search engine optimization including creating a static URL addressing and hierarchical structure, analysis to determine an optimized search engine configuration for each Web page or document, and dynamic processing for each Web page requested by an end user or search engine crawler.

Yet another object of this invention to provide a system and method that is able to deliver generally accepted search engine optimization strategies at all levels (user interface, business logic, data) with minimal integration with the publishing platform to allow the system to operate concurrently with the publishing system, providing all search engine optimization advantages, regardless of the publishing platform used.

The invention itself, both as to its configuration and its mode of operation will be best understood, and additional objects and advantages thereof will become apparent, by the following detailed description of a preferred embodiment taken in conjunction with the accompanying drawing.

When the word “invention” is used in this specification, the word “invention” includes “inventions”, that is, the plural of “invention”. By stating “invention”, the Applicant does not in any way admit that the present application does not include more the one patentable and non-obviously distinct invention and Applicant maintains that the present application may include more than one patentably and non-obviously distinct invention. The Applicant hereby asserts, that the disclosure of the present application may include more than one invention, and, in the event that there is more than one invention, that these inventions may be patentable and non-obvious one with respect to the other.

Further, the purpose of the accompanying abstract is to enable the U.S. Patent and Trademark Office and the public generally, and especially the scientists, engineers, and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

### BRIEF DESCRIPTION OF THE DRAWINGS

FIG. 1 is a block diagram of the typical search engine crawling process;

FIG. 2 is a block diagram of the search engine crawling process of the present invention.

### DESCRIPTION OF THE PREFERRED EMBODIMENT

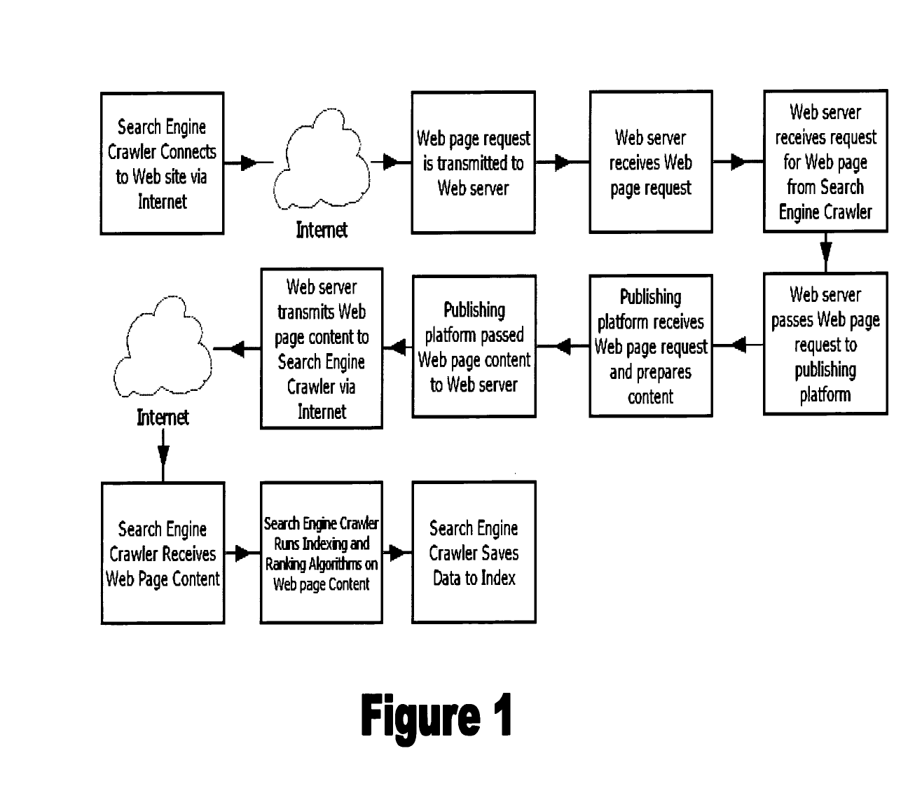

The present invention provides a system and method of modifying the characteristics of a related set of Internet Web pages (organized collectively as a Web site) in real-time, to achieve search engine optimization (SEO) of the Web page components including structure, code and content (text, images and multimedia elements). FIG. 1 shows a typical search engine crawling process after a query is provided. As mention before a search engine crawler, which discovers a Web page, connects to a web site by internet, transmit the web page request to the server and the web server receives the request from search engine crawler. After the Web server receives the request, it passes said request to the publishing platform which prepares Web page content. The Web page content is passed to the Web server and transmitted to said search engine crawler via internet. After the search engine crawler receives the web page content as the response for it request runs the indexing and ranking on the Web page content provided by the publishing platform. Then the Search engine saves the data to Index.

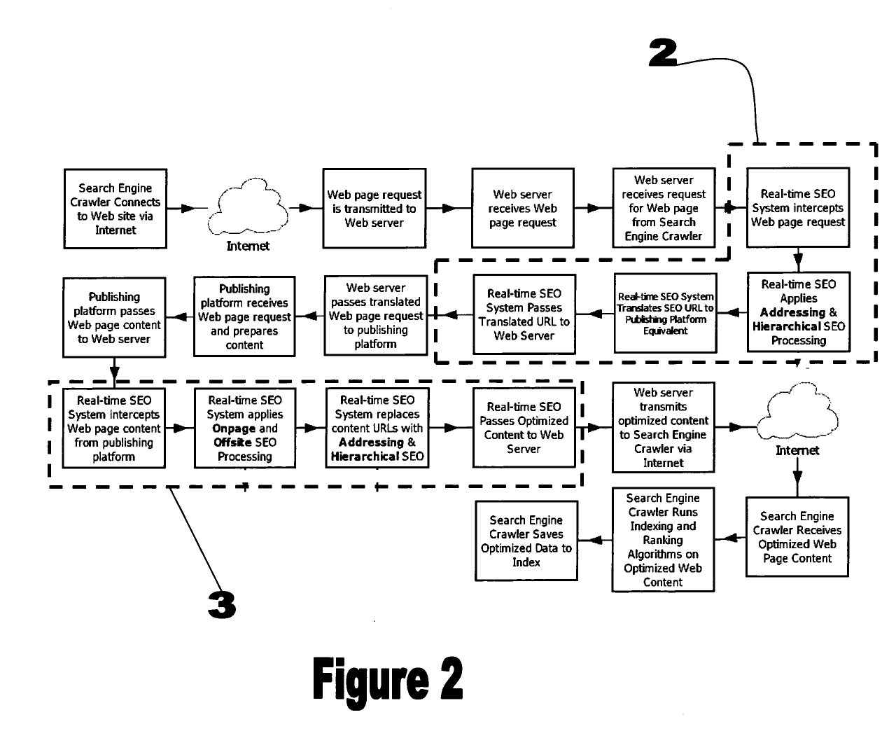

The present invention has almost a similar process but an optimization system prepares Web sites and Web pages to more effectively match the criteria used by search engines when crawling, indexing and ranking, i.e. determining the position of each Web page returned in the search engine result pages (SERPs) as shown in FIG. 2. The optimization method includes modifications to individual Web pages (referred to as “onpage” SEO), to the hierarchy and addressing structure of the complete Web site (or designated sub-section(s) of the Web site) and “offsite” through outbound and inbound link distribution on the World Wide Web.

The method is automated in real-time using several embodiments, which must meet the criteria of having a server configuration allowing a pre-processing (2) of incoming Web page requests by intercepting and processing hierarchical or address optimization prior to retrieving the content from the publishing platform and a post-processing (3) of requested Web page content for onpage and offpage (inbound/outbound linking) optimization prior to being delivered from the publishing platform to the end user via connection to the hosting server, as show FIG. 2.

The following embodiments meet the pre and post-processing criteria:
1. a software application installed on the hosting Web server
2. a software plugin (also referred to as extensions or modifications) installed directly within the server-side publishing software used to generate the Web site (or Web site sub-section(s)) content.
3. embedded within a Web or application server software application or as a plugin, extension, modification, or module for an existing Web or application server software
4. a proxy server acting as an intermediary between end user and the server hosting the Web site, set to handle all incoming traffic (pre-processing) and modifying content returned from the server-side publishing software on the hosting Web server prior to returning it to the end user (post-processing)
5. a Web browser or web browser plugin on any Internet connected device, allowing pre and post processing to be handled on the client side
6. a software development API or add-on module for an existing software development API allowing developers to use the API in their own development of applications meeting the pre and post-processing criteria (see above items 1 through 4).

When pre and post-processing criteria options 1, 3, 4 or 5 are meet optimizations can be applied to all hosted Web pages (or configured sub-sections of the Web site), without limitations imposed by the server-side publishing software application(s) used to generate the Web content.

With embodiments that allow the method to operate without significant integration with the server-side publishing software application(s), the optimizations are completed with limited to no modification of the publishing software application(s) required.

When pre and post-processing criteria option 2 or 6 are meet (see above), embedded logic specific to the publishing software can be included to provide greater optimization quality. If an interface or formal plugin management capability is not included in the publishing software application, modifying the source code of the publishing platform is another method that can be used to complete integration.

As a software plugin/extension/modification (including one developed using an API or API add-on module (option 6)), the optimizations are improved since platform-specific logic can be embedded.

Consumption of available resources (including CPU and memory) of the hosting server for the Web site or Web site sub-section(s) is minimized using performance optimization techniques including minimization of required database queries, algorithmic data caching and optimized content modification algorithms using regular expressions.

Since search engine crawling, indexing, and ranking algorithms vary and are updated periodically (depending on the specific Search Engine provider), optimization factors included in the methodology can be configured for each Web site (or Web site subsection(s)) for which it is applied. Settings affect the processing of the real-time optimizations. The method also handles real-time optimization for a Web site (or Web page content) that is both dynamic (changes frequently) and static (does not change, or changes infrequently).

In the general embodiment of the invention, the system provides a structured methodology for modifying the characteristics of the structure, code, and content of Web sites (and Web pages). The modifications are based on the aforementioned generally accepted SEO strategies, and are completed dynamically in real-time with minimized performance impact. The SEO modifications can be categorized into three main types, applied during pre and post processing and completed at the time a search engine crawler or end user visits a particular Web page or document:
hierarchy and addressing—modifications to the addressing and hierarchical structure of one or more documents (i.e. Web pages or other document formats) within a collection of documents (Web site or Web site sub-section)
onpage—modifications to individual Web page content and code, including processing of embedded link addressing (related to hierarchy and addressing)
offsite—modifications to the inbound and outbound link network between the Web page and other Web pages available on the World Wide Web, including processing of embedded link addressing, and may include communication between the Web page being search engine optimized in real-time and another Web site on the WWW via any available network communication protocol.

As indicated above, both onpage and offsite optimizations must apply hierarchy and addressing information into all related SEO modifications where a link is encountered.

The result of a Web site or Web site sub-section using the invention is real-time application of generally accepted search engine optimization techniques in the categories of (a) hierarchy and addressing, (b) onpage, and (c) offsite SEO; increasing the chances that the optimized Web site or Web pages will achieve better results in search engine crawling, indexing, and ranking.

Some of the benefit of the present optimization method over the crawling, indexing and ranking include:
Crawling—search engines crawl more of the Web site or Web site sub-section's Web pages (or documents) faster (i.e. shorter time period), more thoroughly (i.e. higher percentage of available documents crawled), and more frequently (i.e. documents are re-crawled to discover changes more often in a shorter time period).
Indexing—search engines include more of the Web pages or documents crawled in their searchable index, faster and more thoroughly, which enables them to be returned as search results for end user specified search queries.
Ranking—search engines rank a Web page or document in a better position (i.e. lower in numeric occurrence) for a greater number of keywords or keyword phrases.

Having a higher percentage of a Web site's total Web pages or documents included in the search engine indexes, with each page ranking in a better position for a greater number of keyword or keyword phrases, will result in a greater volume of web traffic. Web traffic is the amount of end users that visit the Web site after discovering it in the search engine results pages for a given search query.

Actual success will depend on how accurate the generally accepted search engine optimization techniques are compared with the underlying search engine algorithms (for crawling, indexing, and ranking) that are in place at the time of processing of the invention's real-time optimizations. Since search engine algorithms vary from company to company, results will also vary from search engine to search engine. However, embodiments of the invention can be created that focus on a particular search engine and apply only search engine optimization techniques generally accepted as having a positive effect by those skilled in the art of SEO.

The invention is not limited to the precise configuration described above. While the invention has been described as having a preferred design, it is understood that many changes, modifications, variations and other uses and applications of the subject invention will, however, become apparent to those skilled in the art without materially departing from the novel teachings and advantages of this invention after considering this specification together with the accompanying drawings. Accordingly, all such changes, modifications, variations and other uses and applications which do not depart from the spirit and scope of the invention are deemed to be covered by this invention as defined in the following claims and their legal equivalents. In the claims, means-plus-function clauses, if any, are intended to cover the structures described herein as performing the recited function and not only structural equivalents but also equivalent structures.

All of the patents, patent applications, and publications recited herein, and in the Declaration attached hereto, if any, are hereby incorporated by reference as if set forth in their entirety herein. All, or substantially all, the components disclosed in such patents may be used in the embodiments of the present invention, as well as equivalents thereof. The details in the patents, patent applications, and publications incorporated by reference herein may be considered to be incorporable at applicant's option, into the claims during prosecution as further limitations in the claims to patentable distinguish any amended claims from any applied prior art.

1. A method of using the system of claim 1 for modifying the characteristics of a Web page or a related set of Internet Web pages in real-time for improved search engine positioning, comprising the steps of:
a) Intercepting a request for a Web page from a search engine crawler;
b) Modifying the hierarchical and addressing structure of the Internet Web page or the related set of Internet Web pages;
c) Creating a static URL addressing and hierarchical structures;
d) Translating said URL to a publishing platform's equivalent;
e) Transmitting said URL to said Web server;
f) Said Web server passing said translated Web page request to said publishing platform;
g) Said publishing platform receiving said Web page request and preparing a content;
h) Said publishing platform passing said Web page content to said Web server;
i) Intercepting said Web page content from publishing platform;
j) Modifying individual Web page content and code, including processing of embedded link addressing;
k) Modifying the inbound and outbound link network between the Web page and other Web pages available on the World Wide Web, including processing of embedded link addressing, and may include communication between the Web page being optimized in real time and another Web site on the World Wide Web via any available network communication protocol;
l) Replacing content URLs with addressing and hierarchical search engine optimization;
m) Passing optimized content to Web server;
n) Web server transmits optimized content to search engine crawler via the Internet;
o) Said Search engine crawler receiving said optimized Web Page Content;
p) Said search engine crawler running indexing and ranking algorithms on optimized web content;
q) Said search engine crawler saving optimized data to index.
